(19) United States
(12) Patent Application Publication
(10) Pub. No.: US 2016/0274611 A1
(43) Pub. Date: Sep. 22, 2016

(54) SMART ELECTRICAL SWITCH WITH ENGERY METERING CAPABILITY

(71) Applicant: Cielo WiGle Inc., Redmond, WA (US)

(72) Inventors: Waseem Amer, Islamabad (PK); Anees Ahmed Jarral, Islamabad (PK)

(21) Appl. No.: 15/069,423

(22) Filed: Mar. 14, 2016

Related U.S. Application Data
(60) Provisional application No. 62/134,012, filed on Mar. 17, 2015.

(51) Int. Cl. G05F 1/66; G05B 15/02; H04L 12/28; H04L 29/08; H04W 4/00

(52) U.S. Cl. CPC G05F 1/66; H04L 67/12; H04W 4/005; H04L 12/2825; G05B 15/02

(57) ABSTRACT

A smart electrical switch with energy measurement and control capabilities is described herein. The smart electrical switch enables a user to control, monitor and manage their appliances and their energy consumption both locally and remotely by taking advantage of an onboard integrated Wi-Fi and implemented algorithms. The user can send control commands to the smart electrical switch via an application installed on a portable electronic device or web application accessed via an Internet browser. The smart electrical switch connects to already deployed Wi-Fi router at a user location to use it as a bridge to communicate between the user, cloud and itself. Consequently; it eliminates the need of any additional hub or concentrator which is a primary requirement in ZigBee, Z-Wave or similar technology. The onboard power management unit ensures optimal use of power by the device. The onboard energy measurement unit measures the actual energy consumption of relevant light to show the actual usage statistics and relevant costs to the user. The measurements are presented in user-friendly manner and give the users insights into their energy spending. The smart electrical switch can operate in a smart mode after collecting enough data to automatically change the operating state of the appliances based on user's use or behavior history associated with the appliance to optimize energy usage.

### CROSS REFERENCE TO RELATED APPLICATION(S)

This application claims the benefit of U.S. Provisional Patent Application No. 62/134,012, entitled “Smart Electrical Switch With Energy Metering capability,” filed on Mar. 17, 2015, which is hereby incorporated by reference in its entirety.

### FIELD OF INVENTION

The present invention relates generally to Machine to Machine (“M2M”) communication technology and the Internet of Things (“IoT”) industry. More specifically it relates to the control, monitor, and energy measurement/management of appliances such as Televisions, Air Conditioners, light producing devices or bulbs, refrigerator, swimming pool heater, dishwasher, dryer, washing machine, etc. by providing remote and/or local access and/or control to the user.

### BACKGROUND

Technical innovations in the Machine to Machine (M2M) and Internet of Things (IoT) industry have enabled users to access, control and manage electrical appliances/devices through wireless connectivity from anywhere in the world. The trends are fast growing to remotely control, monitor and manage electronic devices, actuators and sensors. The increased connectivity options have unleashed avenues to connect, control, monitor and manage consumer electronics devices and appliances. Users are desirous to control appliances remotely by using their smart phones, tablets or web application. For example, a user may want to control their appliance and exactly know its energy usage to save energy and relevant costs.

Users in today's world have multiple types of appliances both at their homes and offices. These appliances are normally controlled by their switches. With the advent of latest technology, innovative ways are being explored to control appliances to add to user convenience and provide energy efficiency. There are inherent drawbacks of the appliance switches e.g. they do not offer remote control and information on energy consumption to the user. In addition, for example, if the switch of any appliance malfunctions, there remains hardly any choice but to get the switch back in proper functional mode to conveniently control the appliance. Additionally, the legacy appliance control switches at user locations do not offer any means of location independent control of appliances to the user. Similarly these do not offer intelligent analytics that can be used as a source to take energy saving measures.

Current smart home control systems that allow users to control their appliances remotely (e.g., turn the appliance ON/OFF using a software application installed on a mobile device) suffer from a lot of drawback. Current smart home control systems do not measure and report energy consumption, and do not calculate estimated cost of energy consumed for consumers to see before receiving their utility bills. Current systems do not give consumers insight into their energy spending habits on a day-to-day basis, or any time the consumer wants to see details about their energy usage/estimated costs. Current smart home systems do not break down energy consumption on an appliance-by-appliance basis, day-by-day, etc. Current smart home control systems do not allow consumers to define criteria or parameters to force the smart home control system to intelligently execute functions to save energy. Example of such functions include the automatic deactivation or alteration of the operation of an appliance (e.g. light bulb, air conditioner, TV, refrigerator, swimming pool heater, dishwasher, dryer, washing machine, etc.) in response to an energy consumption threshold being exceeded.

What is desirable is a smart home control system that solves all of the above issues that existing smart home control systems have not addressed.

### SUMMARY

The present invention comprises of various methods, integrated subsystems, and algorithms as per one or more of the presented embodiments to provide users a location independent control of their electrical switches and connected appliances and give the users deep insight and real-time energy usage data/measurements. The described smart electrical switch can utilize the existing Wi-Fi hub already deployed at a user location to give location independent control to the user over their appliances, therefore eliminating the need for an extra control hub or protocol conversion device. The smart electrical switch offers the interoperability features thus making it possible to associate the smart electrical switch with one appliance type and later disassociate from the same and associate with another appliance type as per users' choice and convenience.

Presented are the methods, algorithms, subsystems of the smart electrical switch along with the data capture and storage applications for effective user analytics to help users smartly manage and control appliances irrespective of their location. The implementation of presented methods, algorithms and subsystems leads to a cloud enabled smart electrical switch for connected appliances. These methods, algorithms, subsystem and the application in one or more of the embodiments or a combination thereof; are presented as a patentable matter.

The cloud enabled smart electrical switch for connected appliances with its methods, subsystems, algorithms, computer programs and various embodiments to perform the user generated actions is presented. The presented system aims at providing control to the user over their appliances irrespective of user location and brand of the appliance and show real time energy consumption of each connected appliance.

The operation of some appliances can be conditional and based on reported energy consumption from multiple other appliances. For example, the described system can turn on an air conditioner in the guest room if the energy consumption threshold has not exceeded x kWh (kilowatt hour) or the total cost of energy consumption has not exceed x $ amount. The threshold can be set by the user. For example, the user can set the threshold in spending dollars and the described smart system will manage the operation of the appliances or selected set of appliances (as defined by the user), and the energy consumption accordingly.

The described system uses intelligent algorithms to measure energy consumption, calculate estimated cost, and makes decisions on operation of some or all available appliances to save energy. Since electricity costs (e.g. $/kWh) vary between countries, states, cities, counties, and utility providers, the described energy management system uses location to calculate costs, determine the utility provider to therefore determine cost per kWh. The described system also uses the operation timestamps of the various appliances to measure energy consumption costs since most providers operate on a tier-based pricing model. For example, Utility provider A might charge more per kWh at certain times during the day. Taking this into account, the described system will prioritize the operation of some appliances over other appliances. For example, the swimming pool heater takes less priority over air conditioner, and the refrigerator takes priority over both, i.e., the swimming pool heater and the air conditioner.

### BRIEF DESCRIPTION OF THE DRAWING(S)

Various subsystems, features and attendant advantages of the invention will become fully appreciated as the same become clearer when considered in conjunction with the accompanying drawings:

FIG. 1 illustrates the block diagram of Smart electrical switch. The onboard communication subsystem, switch control section, energy metering section, microcontroller unit, power management unit and status section are illustrated.

FIG. 2 is a block diagram of the system illustrating the overall system components including smart electrical switches, connected appliances, cloud platform, database and application, locally deployed Wi-Fi router, smartphone application and communication mechanism.

FIG. 3 is a block diagram of the system illustrating main subsystems i.e. user, smartphone and cloud application platform and a plurality of connected smart electrical switches presented as invention here.

FIG. 4 is a block diagram illustrating the options for application scenarios of the invention at various building options i.e. residential, office and vacation etc.

FIG. 5 is a block diagram where a user is capable of communicating, controlling, monitoring and managing multiple appliances directly through smartphone and smart electrical switches.

FIG. 6 is a block diagram where multiple users are capable of communicating, controlling, monitoring and managing multiple appliances directly through smartphones and associated smart electrical switches thus illustrating a concept of family or group.

FIGS. 7A-7E are high-level schematic diagrams illustrating communication arrangements through which local and/or remote users can control appliances in various embodiments of the technology

FIG. 8 is a block diagram illustrating the command operation section in accordance with some embodiments of the technology.

FIG. 9 illustrates the onboard programmatic and algorithmic flows of the smart electrical switch.

FIG. 10 illustrates the onboard programmatic and algorithmic flows of the smart electrical switch at power up.

FIG. 11 illustrates the onboard choice and selection of communication subsystems available on the smart electrical switch.

FIG. 12 illustrates the signup and startup screens of the smartphone application to provide seamless graphical user interface to the user.

FIG. 13 illustrates the screens of smartphone applications used to register the smart electrical switches and associating these with appropriate appliances.

FIG. 14 illustrates the creation, defining and joining functions of family/group of users through smartphone application.

FIG. 15 illustrates the smart electrical switch setup screens of smartphone application and linking the smart electrical switch with available Wi-Fi router(s) at the user location.

FIG. 16 illustrates the main screen and the drop down options of smartphone application including reports, notifications, family/group, appliances and settings.

FIG. 17 illustrates the screens of smartphone application supporting family/group features. The association of one or multiple appliances to one or multiple members can be configured through these screens of the application.

FIG. 18 illustrates the screens of smartphone application showing energy usage information to the user. The graphical presentation of information is also highlighted.

FIG. 19 illustrates the screens of smartphone application showing parameter based energy usage information to the user of the connected appliances to smart electrical switches. The graphical presentation of information is also highlighted.

FIG. 20 illustrates the screens of smartphone application offering energy usage control capability to the user for each connected appliance to the smart electrical switch. This feature of the application plays a vital role in energy saving and providing energy efficiency to the user.

FIG. 21 illustrates the reports and graphical presentation of user analytics for user information.

FIG. 22A-22B illustrates the smartphone application screens for scheduler and timer automation configuration for one or multiple smart electrical switches by the user(s).

FIG. 23 is a display diagram illustrating a timeline screen in accordance with some embodiments of the technology.

### DETAILED DESCRIPTION OF THE PREFERRED EMBODIMENT(S)

The following description is intended to convey an understanding of the invention by providing a number of specific embodiments. It is understood, however, that the invention is not limited to these exemplary embodiments and details.

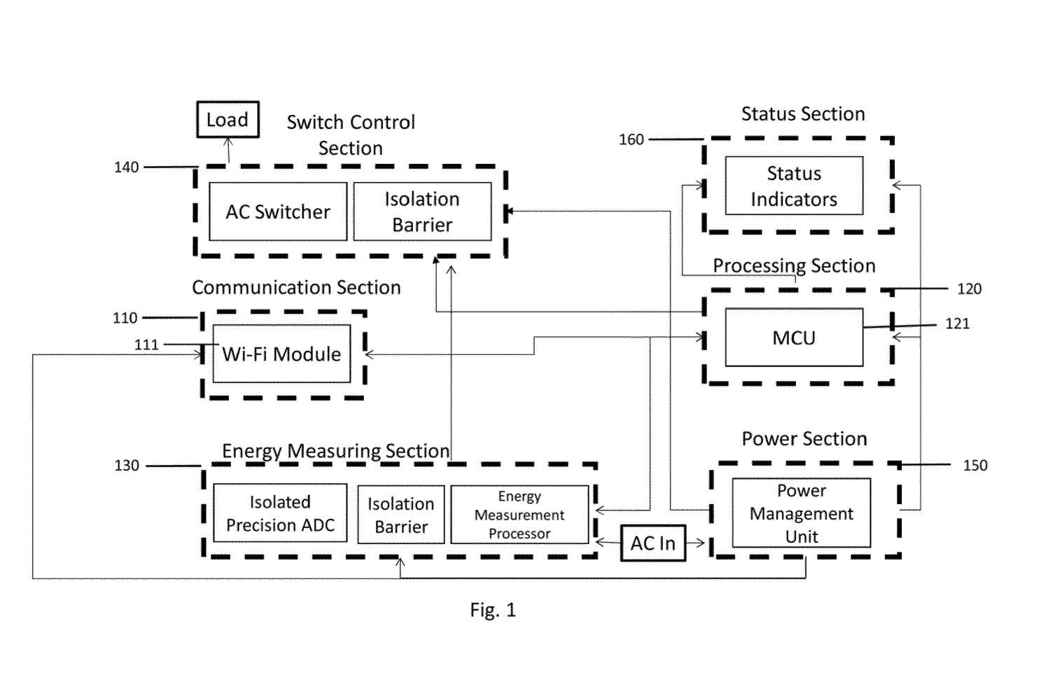

FIG. 1 illustrates components of a smart electrical switch 10 in some embodiments. The illustrated components include an onboard communication section 110, processing section 120, energy measurement section 130, switch control section 140, power section 150, and status section 160. In the illustrated embodiment, the communication section 110 has an onboard communication subsystem: a Wi-Fi module 11. For example, the smart electrical switch 10 can function on Wi-Fi networks that operate on standard frequencies (2.4 GHz or 5 GHz) to send and receive data. Wi-Fi module 111 with implemented programs supports both direct and client mode operations. In some embodiments, the device selects the Wi-Fi operating mode depending upon, e.g., the requirement of operation and power metric indicators. The operation of the appliance can be controlled in response to signals from the processing section or the energy measuring section. The data is sent back to cloud platform 50 for storage, analysis and statistics. The same data is used by the smart electrical switch 10 and onboard intelligent algorithms in conjunction with user controls data to learn about usage styles, usage behavior and implementation of smart control features in the smart electrical switch. Initially the smart electrical switch operates as per user instructions without taking any automated decisions and enters the learning mode. With the increased data in the database and having learned about user lifestyle and usage behavior it offers the user to enable smart control. If a user enables the smart control, the smart electrical switch will make intelligent decisions to offer optimized convenience and control to the user automatically. The described smart electrical switch can be altered to contain an onboard sensor section, such as a proximity detection sensor and other sensors. The role of the sensor section is to measure surrounding conditions in real time. These sensors can be standalone or on a single integrated semiconductor chip (IC). These sensors enable the smart electrical switch to perform functions in response to signals from the onboard sensors. For example, in response to detecting movement by the proximity detection sensor, the smart electrical switch could turn on the light bulb coupled to switch.

In the illustrated embodiment, the processing section 120 has an onboard microcontroller unit 121, e.g., with on-chip flash and random access memory. The microcontroller unit 121 has onboard communication interfaces including, for example, serial communication, a serial peripheral interface, and an Inter-Integrated Circuit (“I2C”) bus for communication with the onboard subsystems. The smart electrical switch 10 has onboard general purpose input/output (“I/Os”) and automatic data capture (“ADC”) for data capture, generating triggers and commands according to loaded program instructions. The microcontroller includes a processing and decision making engine. The programmatic and algorithmic flows are implemented in the onboard memory and are updated by the cloud application platform as required. For example, power metric calculations are part of the onboard algorithms which help the smart electrical switch 10 save power during its operations. The programmatic and algorithmic flows with the help of onboard rules engine enable the smart electrical switch 10 to perform machine learning and to take intelligent decisions based on user habits. Energy measurement section 130 contains circuitry which is responsible for measuring the real time energy consumption of the appliance coupled to the smart electrical switch 10. For example, the energy measurement section can include existing single chip solutions to measure active energy (kWh). The switch control section 140 is responsible for adjusting the operation of the appliance in response to user commands or in response to signals from sensors (external to smart electrical switch or onboard the smart electrical switch), or automatically when operating in smart mode. The power section 150 includes a power management circuitry to ensure optimal use of power by the device.

The onboard status section 160 provides visual status about various modes, conditions and states of the smart electrical switch 10. In some embodiments, red, blue, green and yellow LEDs are used. These can indicate various statuses regarding data transfer, cloud connection, mobile application connection, etc. In some embodiments a combination of two or more LEDs turned on simultaneously indicates system status for user information. In some embodiments, the smart electrical switch 10 includes a display screen (e.g. LCD) that displays operational and status information.

In some embodiments, data in transit between the microcontroller 121 and Wi-Fi module 111 is secured by symmetric encryption such as a block cipher, e.g., AES-128, AES-192, or AES-256, and a one way hashing algorithm such as SHA1. AES block ciphers encrypt and decrypt data in blocks of 128 bits using cryptographic keys of 128-, 192- and 256-bits, respectively. Two-level encryption using AES and SHA1 for data in transit makes it difficult for an attacker to decrypt communication within the smart electrical switch 10 between the microcontroller 121 and the Wi-Fi module 111.

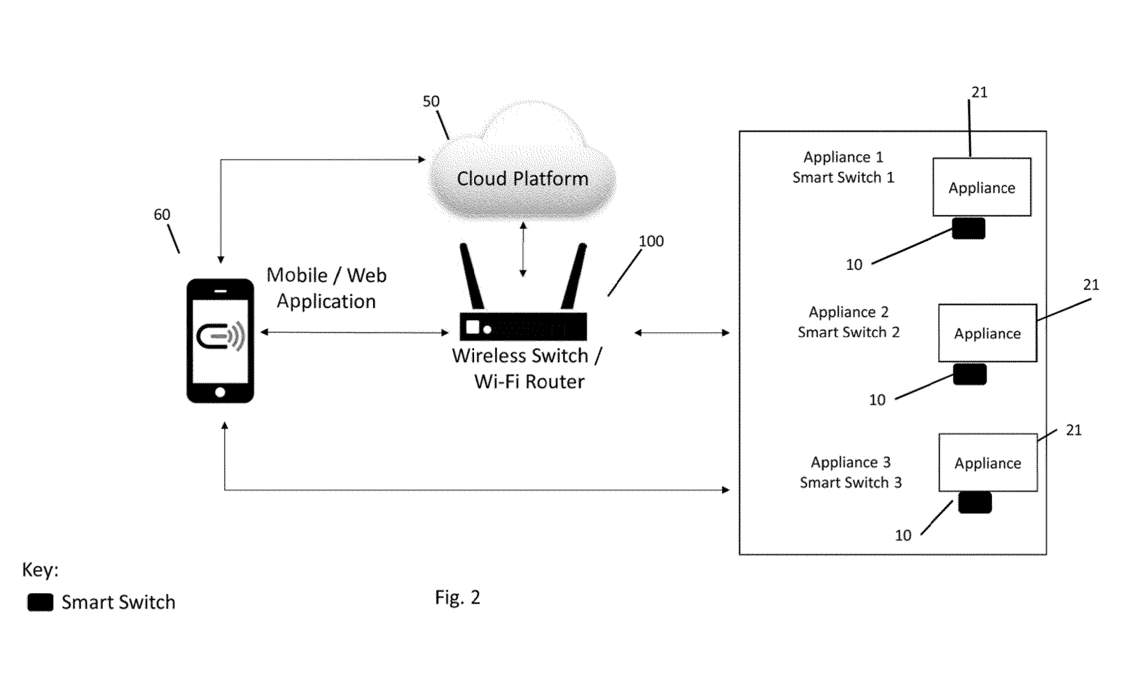

FIG. 2 is a high-level schematic diagram illustrating logical relationships among systems in some arrangements within which the technology can operate. FIG. 2 illustrates overall system components in some embodiments including smart electrical switch 10; a cloud platform 50, e.g., including servers, databases, software applications, etc.; a locally deployed Wi-Fi router 100; and a mobile or web application (e.g., on user electronic devices such as mobile device 60, tablets, laptops, etc.). FIG. 2 illustrates communication links between the system components. The smart electrical switch 10 connects to a cloud application platform 50 through a Wi-Fi router 100 at the smart electrical switch 10 location via a communication module of smart electrical 10.

When the smart electrical switch connects to the Server via TCP sockets it has to inform the cloud about its unique ID Address which is added to the Server's current connections list and is used for further handling the protocols and data for the device. The server checks if the unique ID Address is valid or not and responds with a message accordingly. If the device is not verified, the server closes the connection.

Once the smart electrical switch is connected and listed in the current devices list it starts sending heartbeats after automatically adjusted intervals. The interval is adjusted intelligently and dynamically to balance the load on server side. The heartbeat fulfills multiple purposes. It helps in detecting if smart switch 10 is online or offline. The heartbeat also contains useful information about smart switch 10 such as information regarding schedule timestamps. It has other required information that is used for smart learning algorithms. The Cloud on the other hand keeps a record of the information in the heartbeat and after processing and storing information it sends an acknowledgement to the smart switch with a data packet having useful information for the smart switch. The smart switch status is set to offline if heartbeat is not received within specified time interval. These intervals are dynamic and depend on various parameters including current network situation, device health history and other relevant data.

In various embodiments of the technology, actions can be performed according to one or more “Action Protocols” either locally or remotely or via manually. If smart switch 10 is connected to the same Wi-Fi router 100 or network as the user's electronic device (e.g., a mobile device), the actions are performed locally. In case the smart switch and application are not connected to the same Wi-Fi router 100, the actions are performed remotely via the cloud platform 50. A third scenario occurs when the actions are performed manually, which results in the device sending “Backtrack” information to the cloud platform 50 using a “Backtrack protocol.”

In a Local action protocol, the mobile app sends the action information to smart switch 10 which performs the action on the appliance, and the app sends an acknowledgment to let the mobile app know when the action is performed. The mobile device then informs the cloud platform 50 that a local action was performed. In a remote action protocol the mobile device sends action information to the cloud platform 50. The cloud platform 50 processes the information and sends it to smart switch 10 which then performs the action on appliance 20 and sends an acknowledgement to the cloud platform 50. The cloud platform 50 sets the status of the action as completely performed and sends a success notification to the mobile application. In a Backtrack protocol, the smart switch receives the action information from appliance 20 and informs the cloud platform 50 that an action was performed manually. The cloud platform 50 stores the action information and sends a backtrack notification to the mobile application of the user for which the smart switch 10 is registered.

In various embodiments, the cloud platform 50 provides cloud storage (e.g., cache) and database services. The cloud platform 50 acts as a bridge between hardware and/or software of smart electrical switch 10, mobile devices 60, and mobile apps/web applications. For example, the cloud platform 50 provides utilities for mobile applications to communicate with a database server through predefined application programming interfaces (“APIs”). The cloud platform 50 service use APIs to store smart electrical switch 10 data on a cloud database, so that the data is secure and accessible by the user anywhere. The cloud platform 50 provides services for encryption and decryption of commands and data, maintaining privacy of the user. The cloud platform 50 maintains information about smart electrical 10 status and provides services for scheduling, statistics, and triggers for firmware over-the-air (“FOTA”) updates of smart electrical switch 10.

User actions are recorded and stored in the cloud application platform 50. For example, in various embodiments of the technology, an activity log is stored in the central database of cloud application platform 50 and acknowledgments and/or notifications are sent to one or more users smart phones 60.

The cloud platform 50 and mobile or web application accessed from a users' mobile device can manage data including data at rest, referring to inactive data that is stored physically in any digital form (e.g. databases, data warehouses etc.), and data in transit, referring to information that flows over a public or untrusted network such as the Internet and data that flows in the confines of a private network such as a corporate or enterprise Local Area Network (LAN). In various embodiments, the cloud platform 50 and mobile or web application 61 include security measures such as storing all data in secure data centers with a trusted service provider, using intrusion detection and intrusion prevention systems, and using distributed computing technology to improve efficiency, reliability, and resilience against denial of service attacks. In addition, the technology includes redundant backup servers and failover IP address functionality so that devices 10 can connect to the cloud platform 50 even when a cloud platform 50 server is down, e.g., for maintenance. The user actions from the mobile software application are either sent directly from the user app to smart electrical switch 10 (whenever the user is in the same location as smart electrical switch 10 is e.g. home—in this case, actions are performed and later app updates the database at cloud to keep the record) or when a user is outside, the app sends all actions to cloud and cloud sends the actions to the smart electrical switch 10 and gets an acknowledgement of action performed from smart electrical switch. Therefore; a complete history of actions is kept on the cloud and this data is used to learn about user behaviors and later make suggestions for automated actions for energy efficiency to the user. The data is also used to show the user a history or timeline of their activities, where they can see the full audit trail of their usage. The data is also used to generate statistical graphs to the user about their usage styles.

Smart electrical switch 10 can be controlled in different modes. In a Wi-Fi Direct mode, the smart electrical switch 10 can be controlled directly from a Wi-Fi enabled mobile device without the need of a home Wi-Fi router. This is a built-in functionality in the smart electrical switch 10. All commands executed are locally saved in the mobile app database and as soon as it is linked to the Internet, the data is transferred to the cloud to keep the database updated for optimized statistics. A second mode of operation is called “home mode”. When the user mobile device is connected to the home Wi-Fi Router which is the same router on which the smart electrical switch is connected to, then the appliances can be controlled without the need of Internet accessibility. Data on executed commands are locally saved in the mobile app database and as soon as it is linked to the Internet, the data is transferred to the cloud platform 50 to keep the database updated for optimized statistics. A third mode of operation is called “Cloud Mode”. In order to control smart electrical switch 10 over the Internet, smart electrical switch 10 and mobile device must be connected to the Internet.

The main components of the smart electrical switch 10 system are smartphone application 60 which executes on user electronic devices 21 and cloud application platform 50. These components remain essential in any of the embodiments of system deployments.

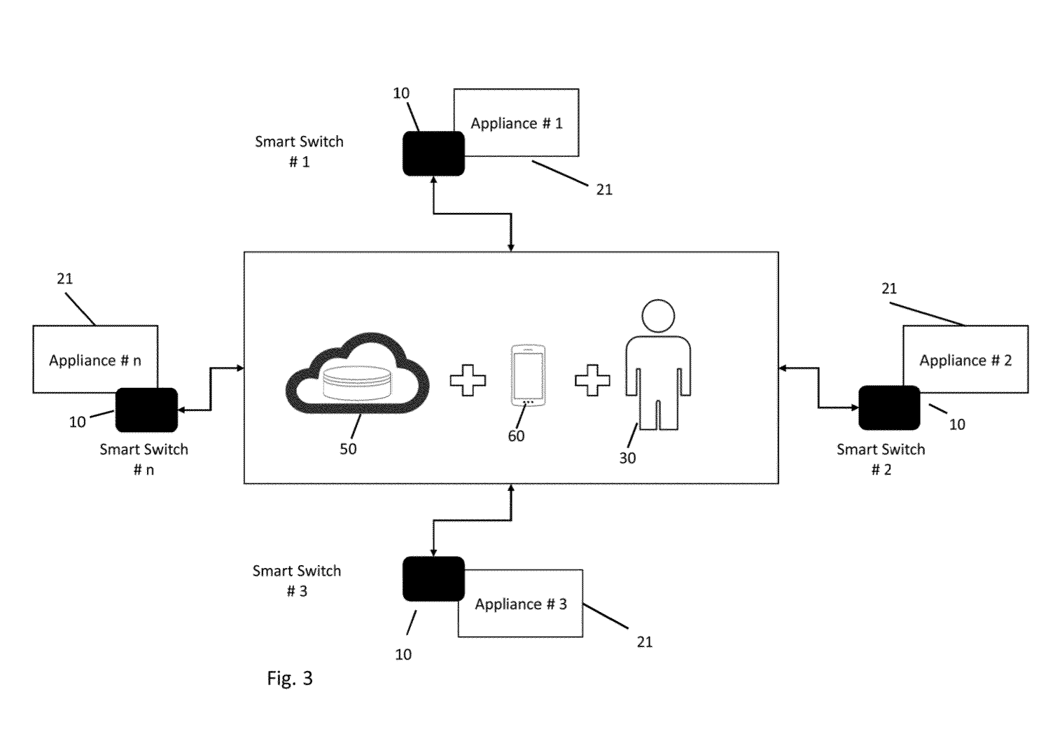

FIG. 3 shows a plurality of smart electrical switches 10 coupled to appliances 21. User 30 can control, monitor and manage their appliances 21 through their smartphone(s) 60 and smart electrical switches 10 irrespective of user 30 location. The smart electrical switch controls associated appliances through onboard subsystems as depicted in FIG. 1. The acknowledgements and notifications are sent to user 30 through smartphone and smartphone application 60 and activity log is stored in cloud platform application database 50.

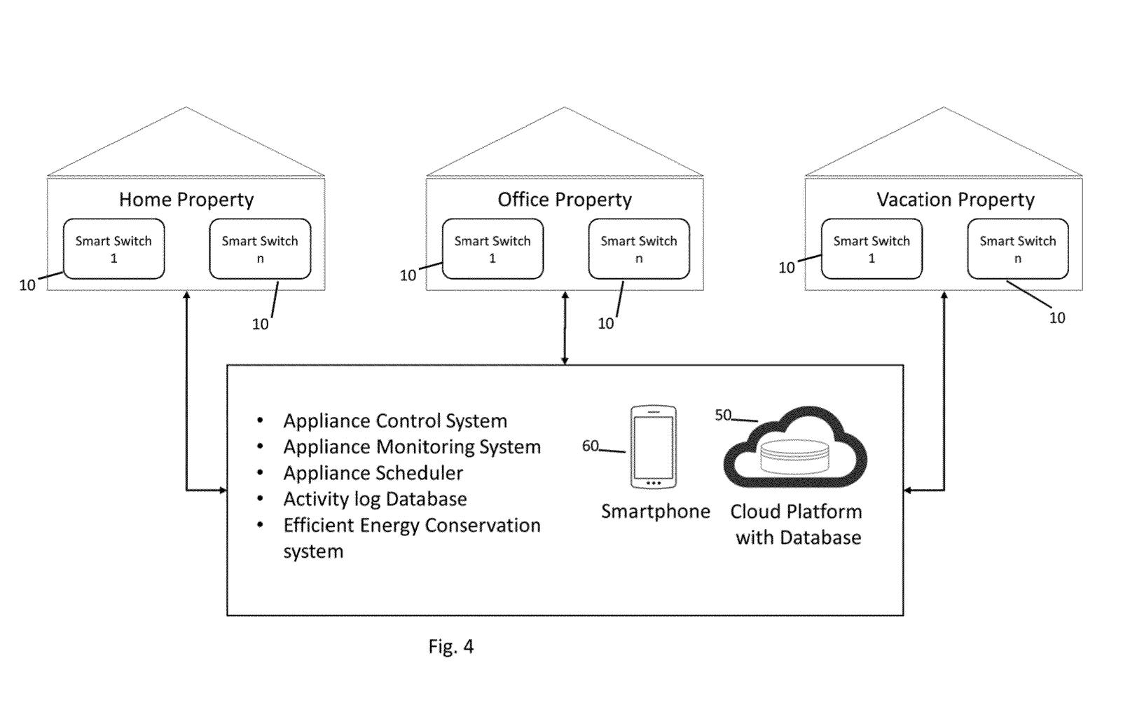

FIG. 4 is a high-level schematic diagram illustrating embodiments in which the technology can control appliances at multiple properties. FIG. 4 shows application of the technology at various buildings, e.g., residential, office, vacation property, etc. The technology allows the user to deploy systems under various embodiments to control, monitor, and manage their light at one or plurality of buildings. Smart electrical switches 10 can be deployed at multiple locations and user(s) can control the associated appliances through a mobile or web interface 61 irrespective of their location(s). In some embodiments the user can choose to deploy multiple devices 10 at the same location for multiple appliances 21, e.g., one device 10 per appliance 21 for cloud enabled control, monitoring and management of appliance 21 irrespective of user location.

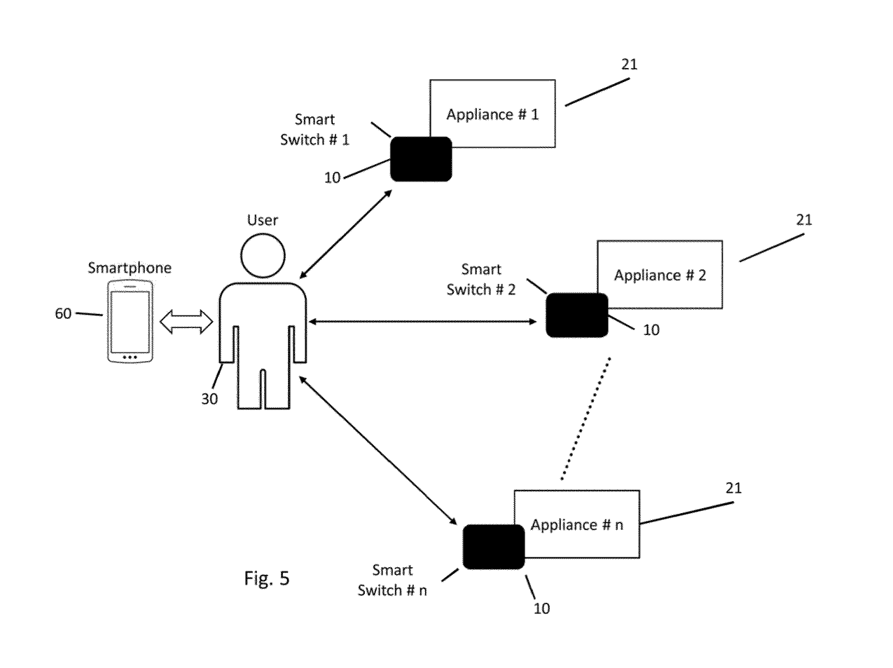

FIG. 5 illustrates one of the deployment embodiments of the system. It is a schematic diagram where a user 30 is capable of communicating, controlling, monitoring and managing multiple appliances 21 coupled to smart electrical switches directly through software application installed on smartphone 60.

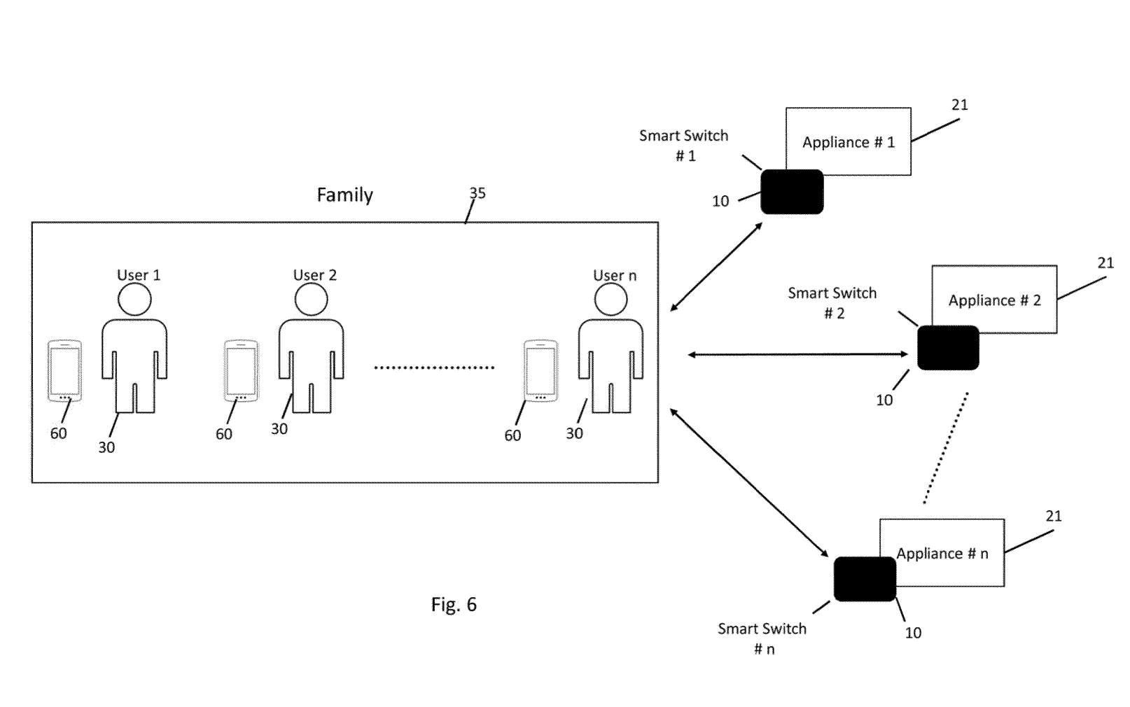

FIG. 6 is a high-level schematic diagram illustrating embodiments in which the technology enables multiple users to control multiple appliances. In some embodiments, multiple users 30 that belong to a family or group 35—are capable of communicating, controlling, monitoring and managing multiple appliances 21 coupled to multiple smart electrical 10 switches 10 directly through smartphones 60. In some embodiments, multiple users 30 are assigned to one device 10. In some embodiments there can be multiple users 30 assigned to multiple devices 10. In some embodiments there can be one user 30 assigned to multiple appliances 21 through associated devices 10 that are geographically apart. In some embodiments there can be multiple users 30 assigned to multiple appliances 21 through associated devices 10 that are geographically apart. The presented technology supports assignment of user(s) 30 through interactive graphical user interface which is part of the software application 61 and backend algorithmic and programmatic flows for effective remote monitoring, control and management of appliances 21 through associated devices 10. The technology thus leverages cloud-enabled control, monitoring and management capabilities to users 30 for assigned appliances 21 through associated devices 10. Such implementation offers a family architecture of system usage and operation under various embodiments

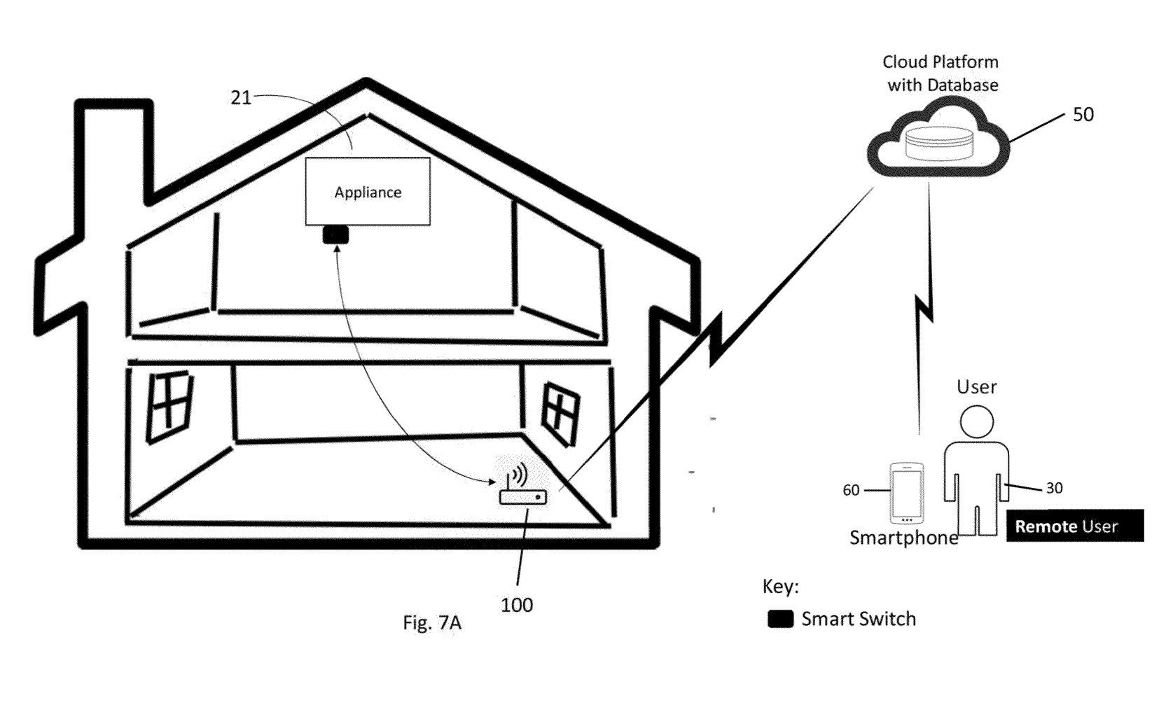

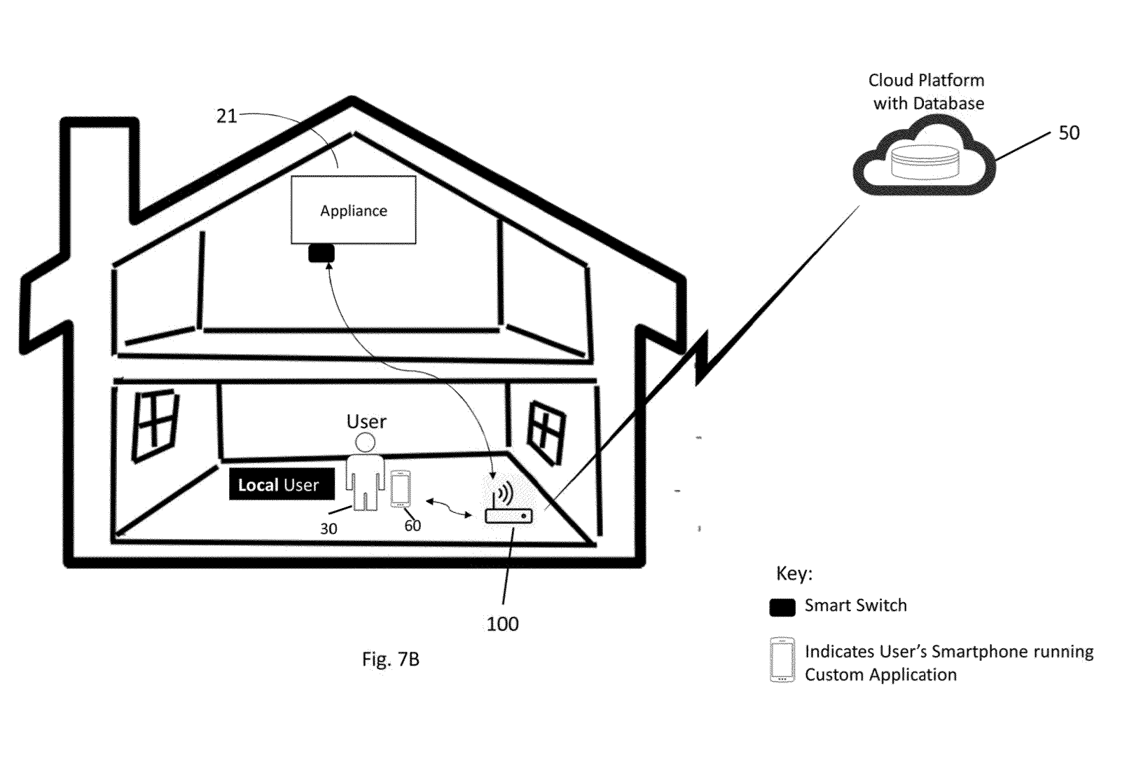

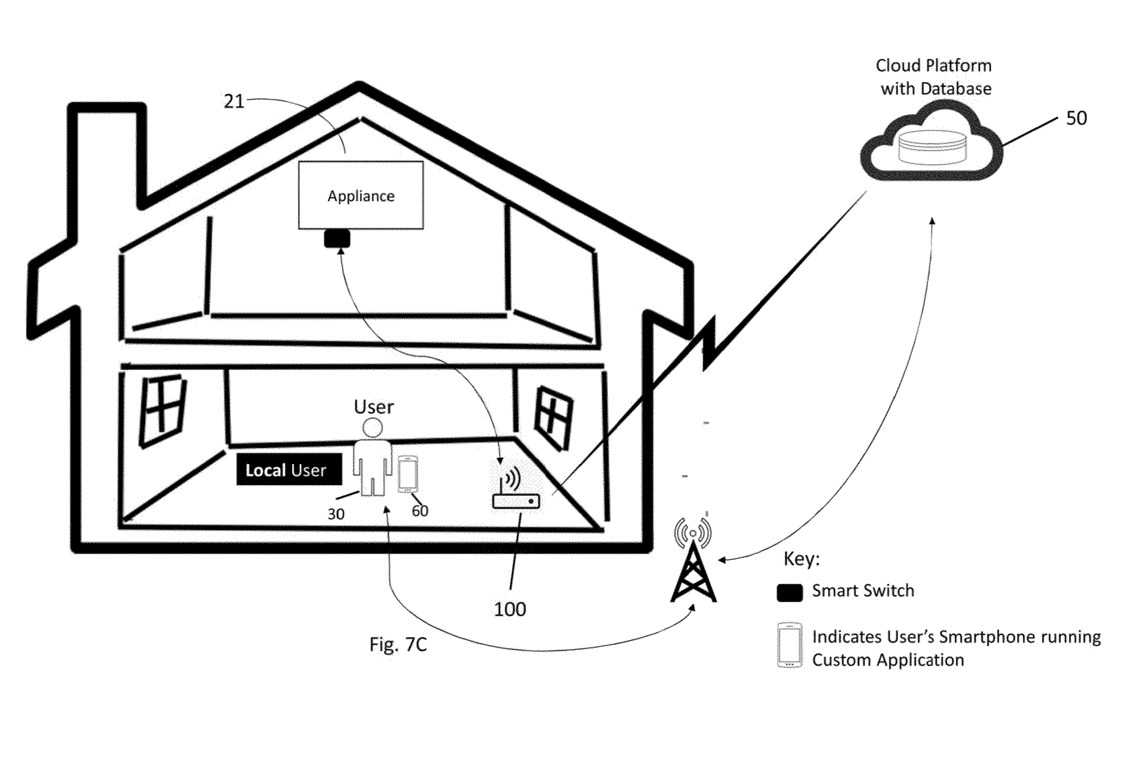

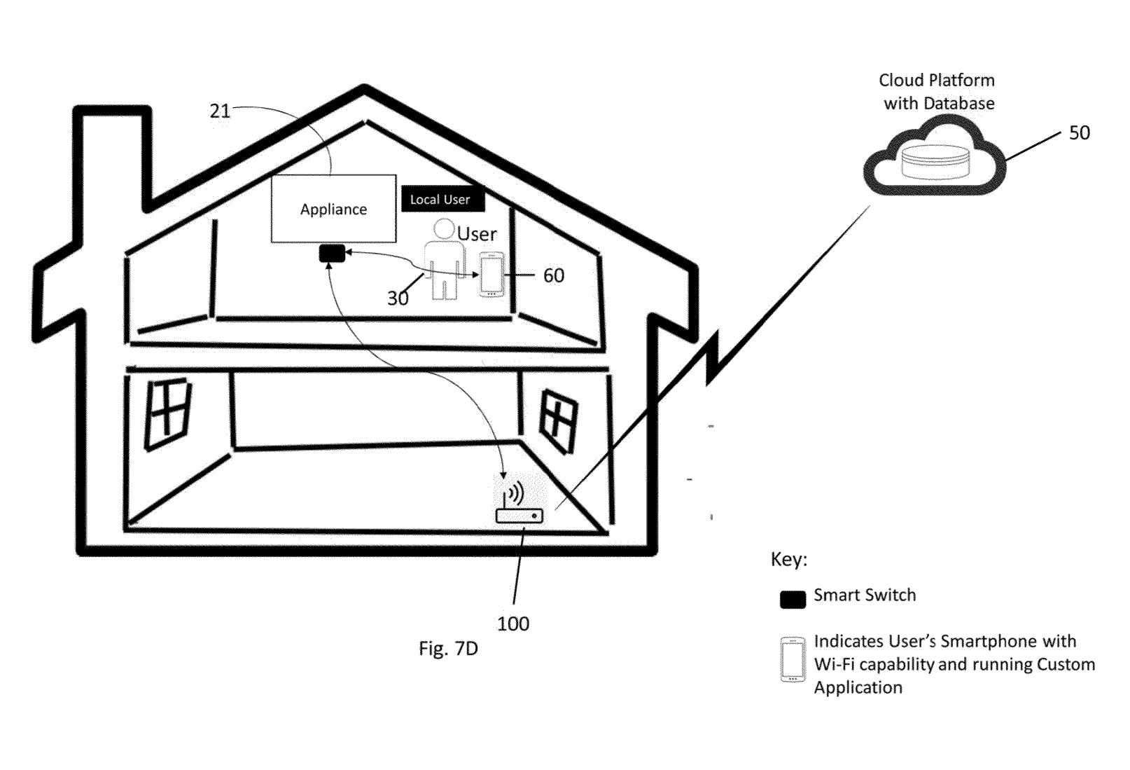

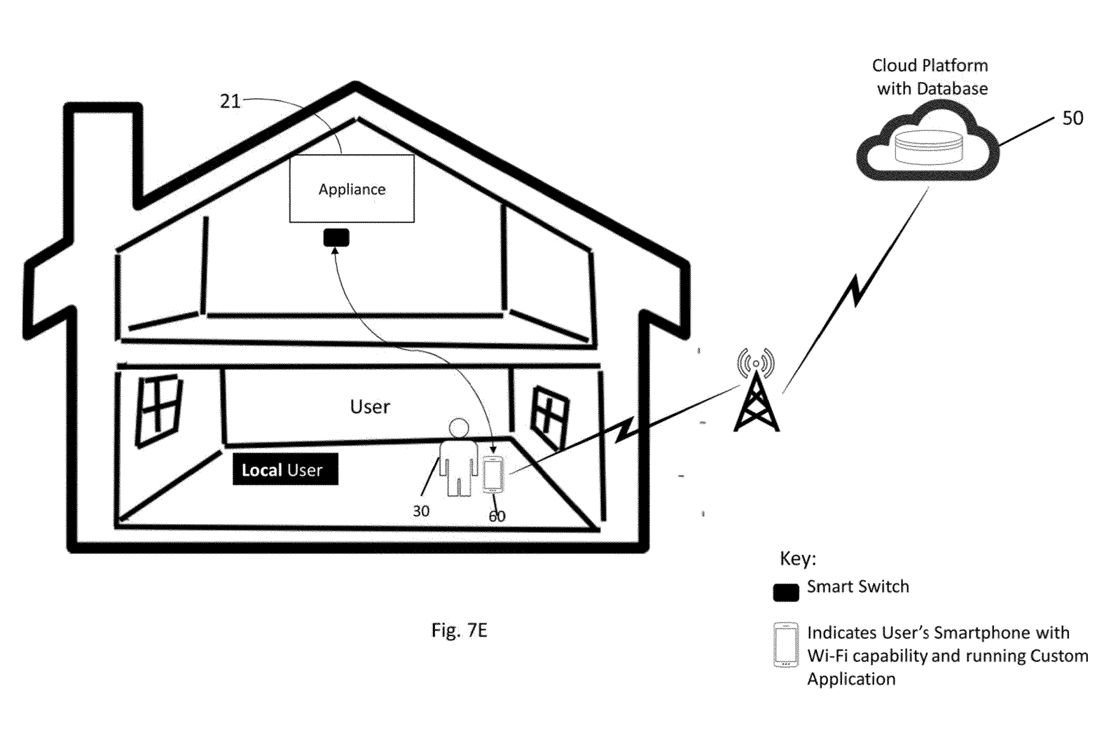

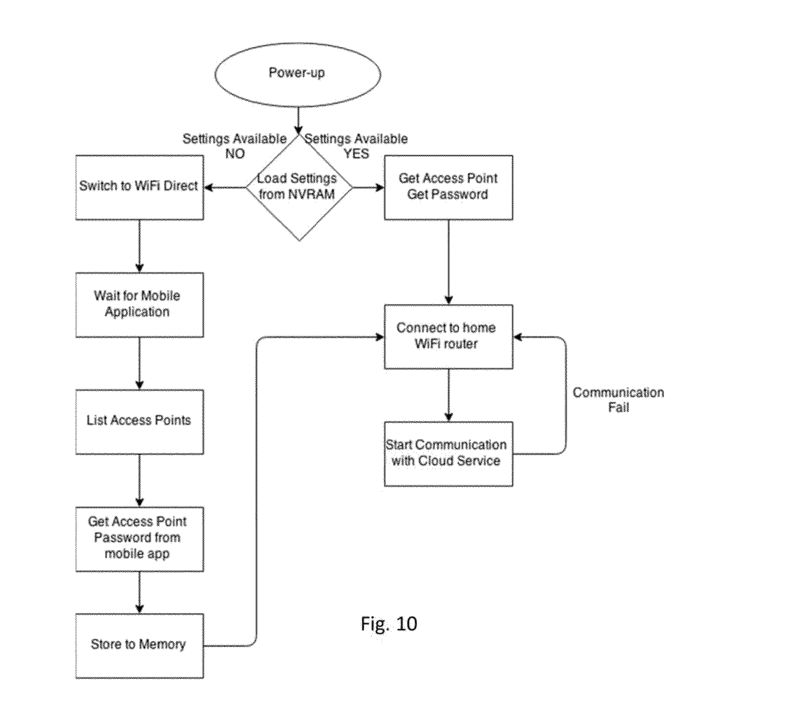

The system has multiple application embodiments wherein it can communicate. These examples are presented in FIGS. 7 to 11 and explained herein. It should be noted that there is no intent to limit the disclosure to these applications forms only but to explain various possible options and their spirit and scope for versatility of the application. The intention is to cover some of the possible modifications, equivalents and alternatives falling within the spirits and scope of the disclosure.

FIGS. 7A-7E are high-level schematic diagrams illustrating communication arrangements through which local and/or remote users can control appliance(s) 21 connected to smart electrical switches 10 in various embodiments of the technology. It should be noted that there is no intent to limit the disclosure to these arrangements; together with the arrangements described below, various possible options, modifications, equivalents, and alternatives fall within the spirit and scope of the present disclosure.

FIG. 7A illustrates a possible data communication mechanism where a remote user 31 is able to control, monitor and manage appliance 21 through smartphone application 60 and cloud application platform 50. The user 31 controls appliance 21 through associated smart electrical switch. The command string from user 31 through a smart phone application running on smartphone 60 is communicated to the smart electrical switch through cloud application platform 50 and local Wi-Fi router 100. The communication between smart electrical switch and Wi-Fi router 100 is based on local Wi-Fi connection. The communication of acknowledgement from the smart electrical switch to the user smartphone application 60 is through local Wi-Fi router 100 and cloud application platform 50. The same communication mechanism is used to log activity feed in the cloud application platform database 50.

FIG. 7B illustrates a possible communication mechanism where a local user 30 is able to control, monitor and manage connected appliance 21 through smartphone application running on smartphone 60 and cloud application platform 50 and local Wi-Fi router 100. The user 30 controls appliances 21 through associated smart electrical switch. The command string from user 30 through their smartphone application is communicated to the smart electrical switch through local Wi-Fi router 100. The communication between the smartphone application and the local W-Fi router 100 as well as between local Wi-Fi router 100 and smart electrical switch is via Wi-Fi. The communication of acknowledgement from the smart electrical switch to the user smartphone application is through the local Wi-Fi router 100 and cloud application platform 50. The same communication mechanism is used to log activity feed in the cloud application platform database 50.

FIG. 7C illustrates a possible communication mechanism where a local user 30 is able to control, monitor and manage connected appliance 21 through smartphone application running on smartphone 60, cloud application platform 50 and public cellular network infrastructure. User 30 controls appliance 21 through associated smart electrical switch. The command string from user 30 through their smartphone application is communicated to the smart electrical switch through public cellular infrastructure link, cloud platform 50 and local Wi-Fi router 100. The communication of acknowledgement from the smart electrical switch to the user smartphone application 60 is through Wi-Fi router 100, cloud application 50 and public cellular infrastructure.

FIG. 7D illustrates a possible communication mechanism where a local user 30 is able to control, monitor and manage connected appliance 21 through smartphone application running on smartphone 60 and cloud application platform 50. User 30 controls appliance 21 through associated smart electrical switch. The command string from user 30 through their smartphone application is communicated to the smart electrical switch through Wi-Fi connection between both (e.g., Wi-Fi Direct). The communication of acknowledgement from the smart electrical switch to the user smartphone application 60 is through Wi-Fi connectivity and cloud application platform 50. Smart electrical switch uses local Wi-Fi router 100 to log activity feed in the cloud application platform database 50 through Wi-Fi connectivity.

FIG. 7E illustrates possible data communication mechanisms in which local user(s) control the appliance through direct communication between the local smartphone and smart electrical switch. The communication between the local smartphone and the smart electrical switch is based on direct communication, and the communication between the local user and the cloud application platform is based on public cellular telephone infrastructure.

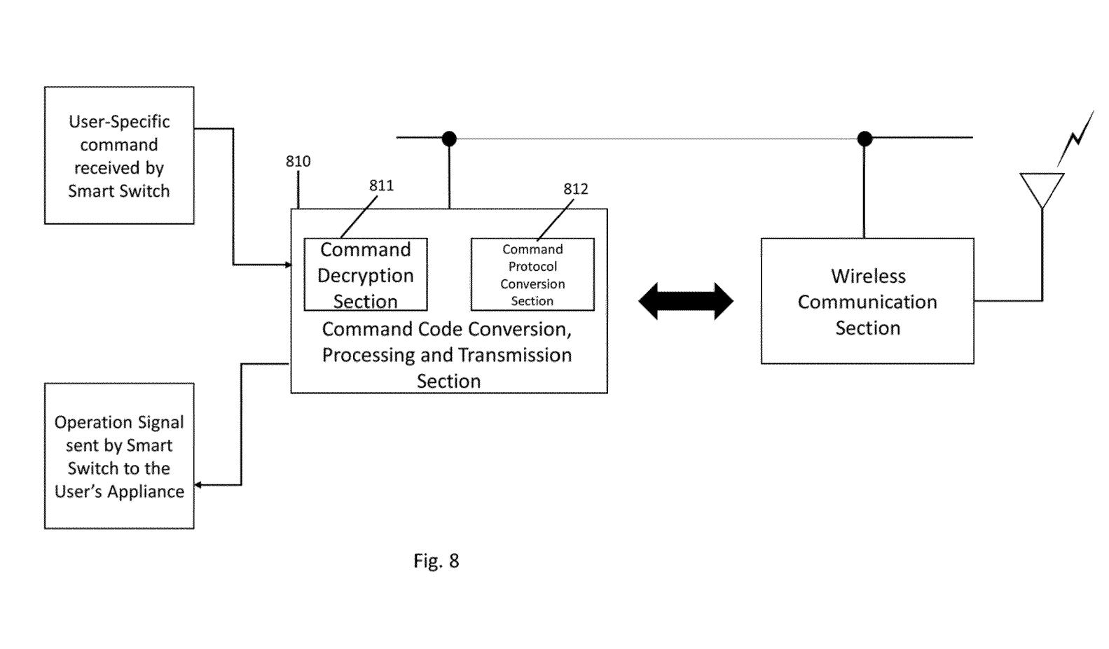

FIG. 8 is a block diagram illustrating how commands received by the smart electrical switch are processed in accordance with some embodiments of the invention. The illustrated subsystems include a command operation section 810 which includes an onboard command decryption section 811 and command protocol conversion section 812, and an interface for wireless communication. The illustrated subsystems enable conversion, processing, and transmission of user-specific commands 801 to the user's appliance 21. The command operation section 810 of smart electrical switch performs related processing on the user-specific commands. The processing includes command decryption 811 and command protocol conversion 812 to operational signals that the switch can communicate to the appliance.

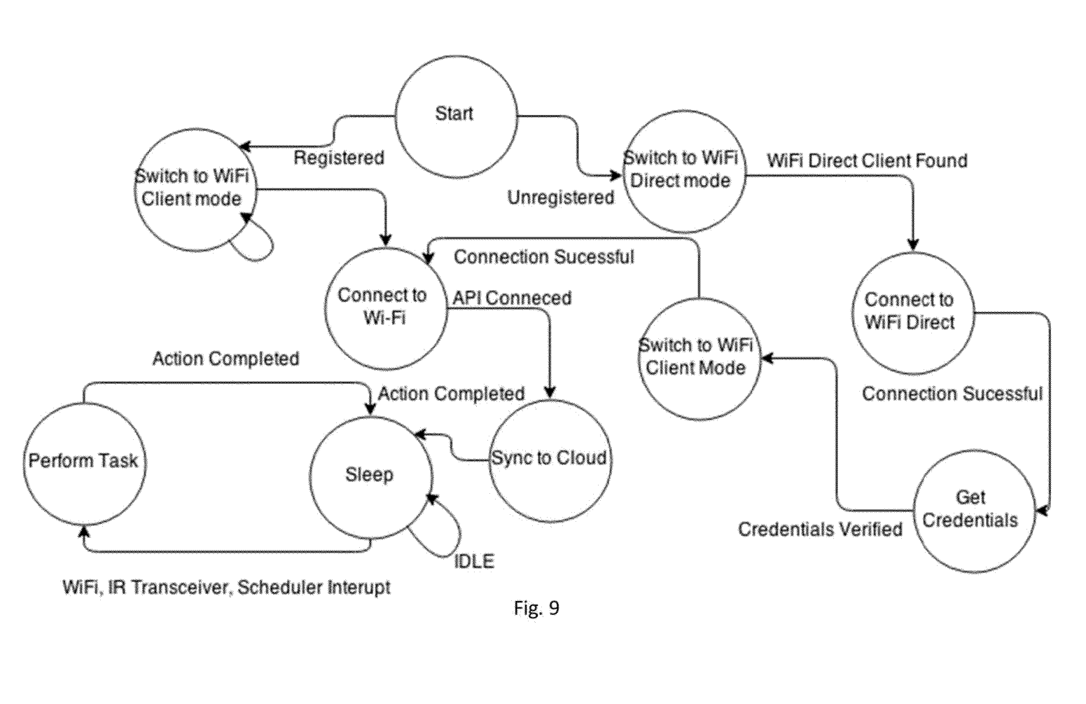

FIG. 9 illustrates a state diagram of the communication routes and decisions made by the smart electrical switch in order to pass instructions. Start state 901 is the power-on self-test (POST). If the smart electrical switch is registered, associated with a user, family, SSID or a service, it calculates the power matric probing all components and identifying system health. If the smart electrical switch is unregistered, the state will switch to Wi-Fi Direct mode and search for Wi-Fi Direct clients. After getting and verifying Wi-Fi communication credentials by successfully connecting to Wi-Fi Direct channel, the smart electrical switch state will switch to Wi-Fi client mode and connects to home wireless router.

FIG. 8 is a flow diagram illustrating steps typically performed by a smart switch at power up to start communication with a cloud service in accordance with some embodiments of the technology. Upon power up, the smart electrical switch searches internal NVRAM (nonvolatile random access memory) for system setting. By default, these are empty. The settings include data on Wi-Fi home router, username, password, power settings etc. When it fails to locate these settings, the smart electrical switch switches its Wi-Fi module to Wi-Fi direct mode. The mobile application connects to smart electrical switch via Wi-Fi direct and queries for listing available access points. The mobile application gets the name and password from the user and saves it. The smart electrical switch then switches Wi-Fi module back to client mode and connects to the home Wi-Fi router so that communication to the cloud platform can be established.

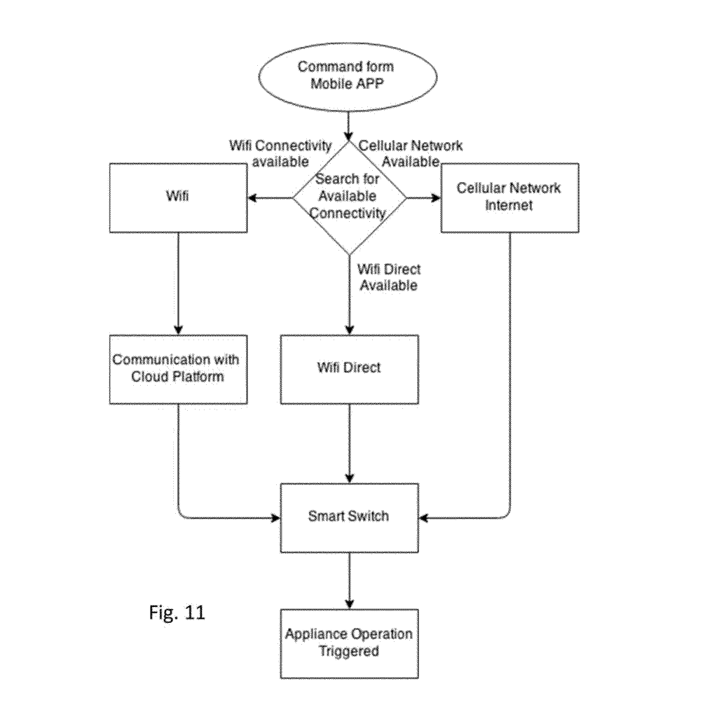

FIG. 11 is a flow diagram illustrating the steps involved in communication a command to the smart electrical switch. The user device can issue commands to the smart electrical switch via direct communication (Wi-Fi) direct, via Wi-Fi, or via a cellular network that communicates the commands to the smart electrical switch via the cloud platform (e.g., user is remote from the location of the smart electrical switch).

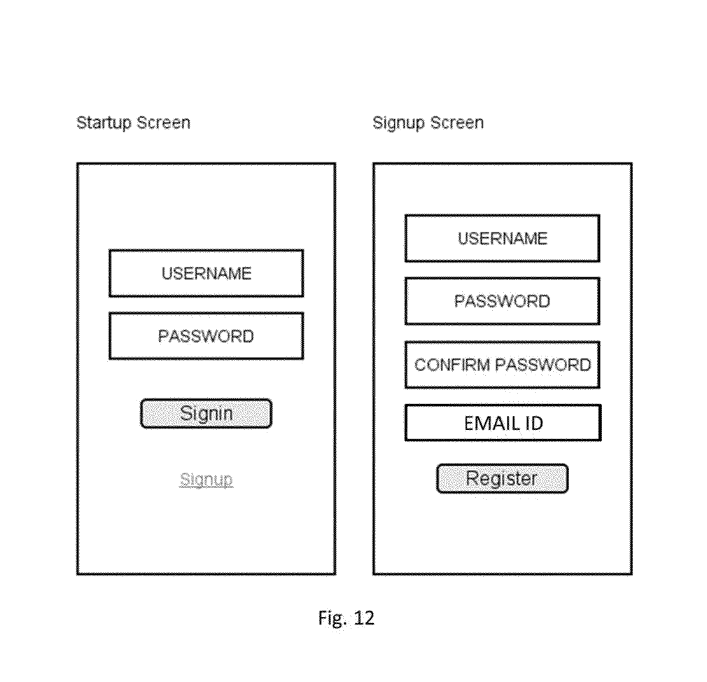

Referring to FIG. 12, it shows mobile application's startup screens of signing in an existing user and registration of new user. The sign in screen accepts the inputs of existing username and password of a registered user and displays “sign in”/“sign up” buttons. On the other hand, sign up screen requires the inputs of username, email, password and password confirmation of a new user and displays a “register” button.

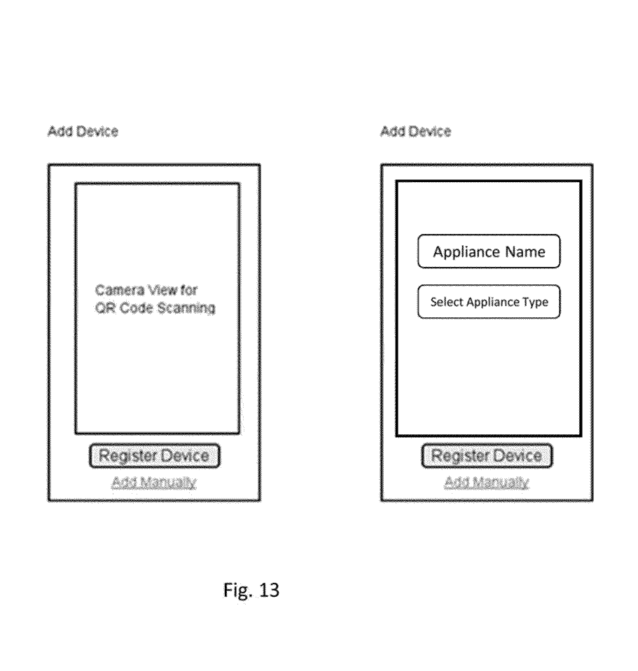

FIG. 13 illustrates the registration process. Users can register the smart electric switch via a QR code scanning option which automatically detects the smart electric switch identification (ID) and stores it in the cloud against specific user. During the registration phase, the customized software application running on the mobile device retrieves the location of the mobile device and communicates it to cloud platform where it is stored in one or more databases and become associated with the user profile and smart electrical switch. The cloud platform hosts a database that contains data about various utilities providers in different locations (countries, states, cities, counties) as well as corresponding electricity rates (e.g., cost per kWh). This enables the customized software to calculate costs of energy consumed based on energy consumption measurements and reporting from the smart electrical switch. The location of mobile device can be obtained in multiple ways. For example, the location of the mobile device can be based on the GPS coordinates of the device, or the location of the wireless Access Point the mobile device is connected to. There are many known ways for a mobile software application to obtain and report the location of the mobile device. For example, mobile applications designed to run on Apple iOS devices use the Apple's Core Location framework to locate the current position of the device. The smart electrical switch can be delinked from one location and linked to another (in case the owner of the smart electrical switch moves to a different city or state). In some embodiments, the smart electrical switch can report data to a remote server that can compute its location. Such data might be related to the access point that it is connected to. Internal algorithms of the system ensure that smart electrical switch location is updated every time it is delinked from existing Wi-Fi router and linked to a new Wi-Fi router.

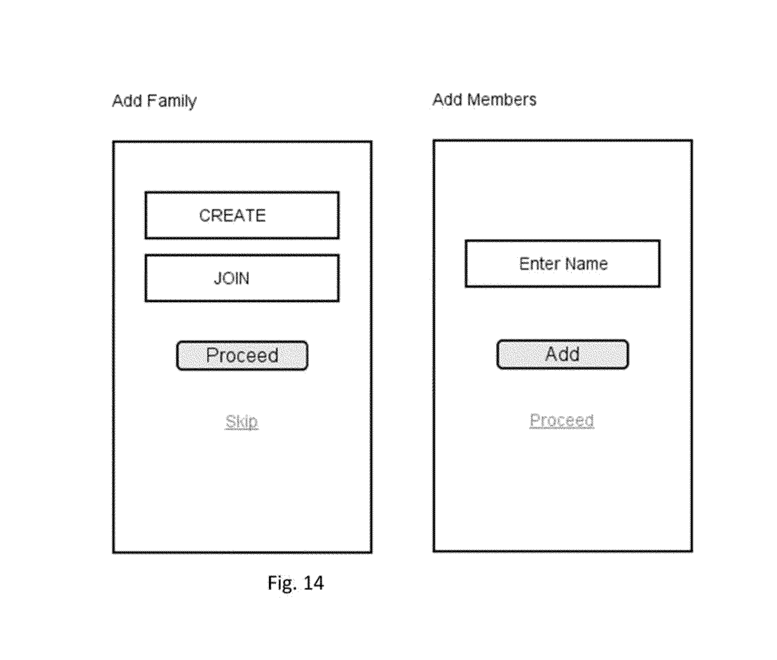

Referring to FIG. 14, it shows mobile application's family registration options screens. User has the option to create a new family group or join the existing as a new member. The new member can have access to existing smart electrical switch(s) associated with the family or can add new ones.

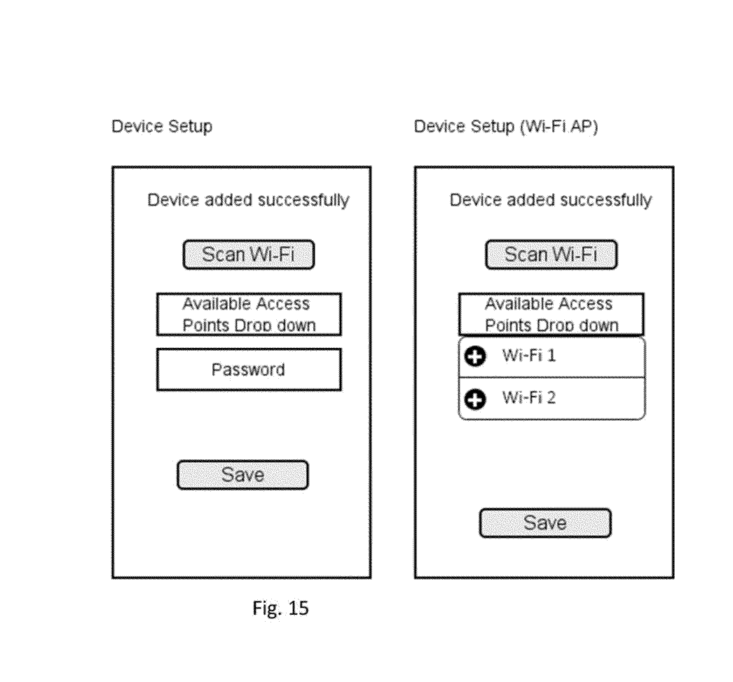

Referring to FIG. 15, it shows mobile application's device Wi-Fi communication setup screens. User can select available Wi-Fi access points from a drop-down menu and enter the access point password in order to establish communication through it. The Wi-Fi access point information and password will be saved in mobile application and cloud platform by selecting the save option.

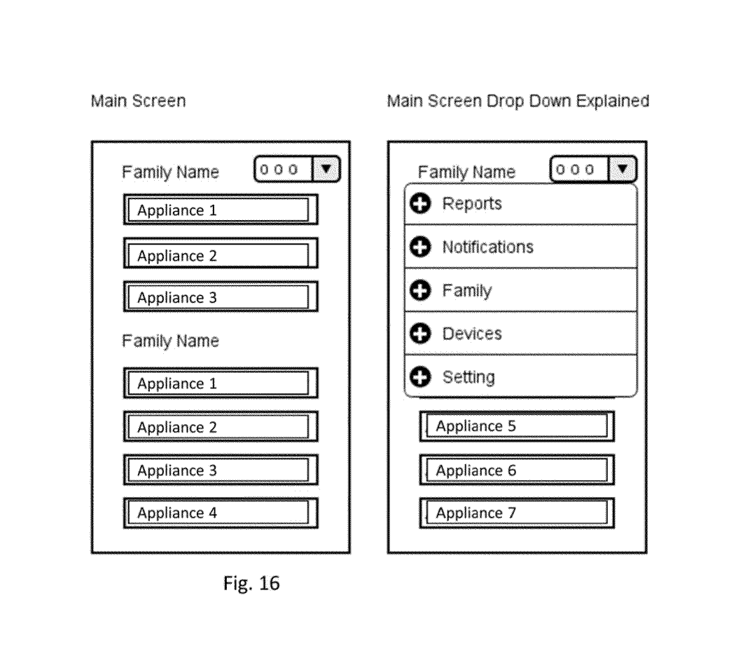

Referring to FIG. 16, it shows mobile application's family associated appliances and drop down options screens. List of appliances associated with a specific family is shown. More than one family can be registered as well as more than one appliance can be associated with each family. The options drop down menu gives user access to graphical reports, notifications, family information, associated appliances information, and settings screens.

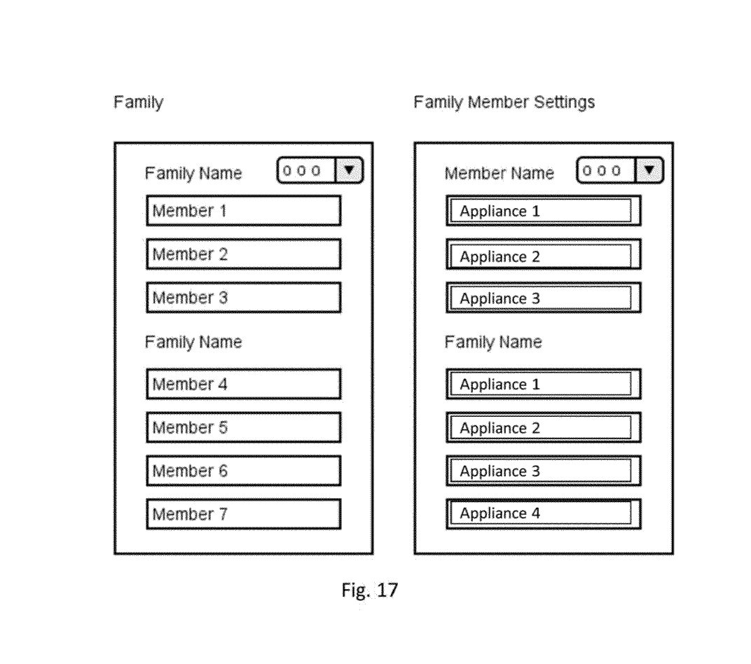

Referring to FIG. 17, it shows mobile application's family associated appliances and member associated appliances screens. List of appliances associated with a specific family is shown. There can be more than one families registered and more than one appliances associated with each family. Additionally, list of smart electrical switches associated with each member is shown here. There can be more than one members registered in a family and more than one smart electrical switches associate with each member of the family.

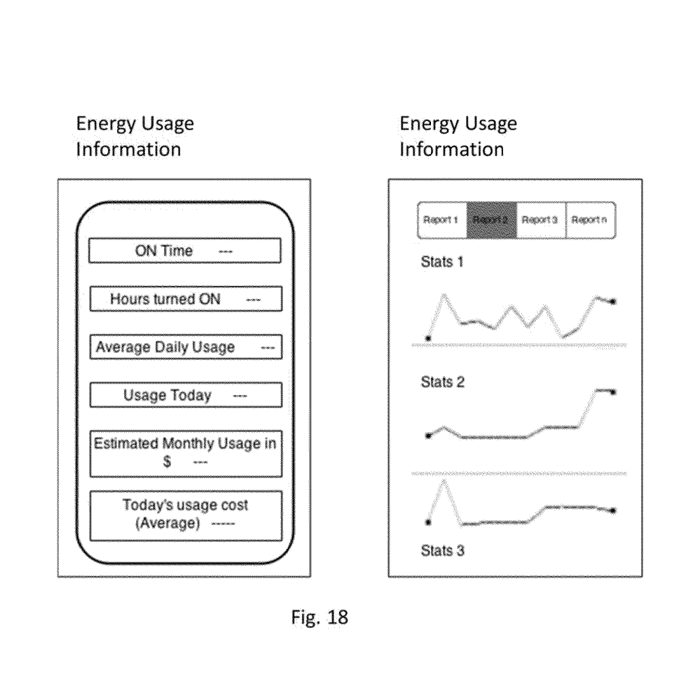

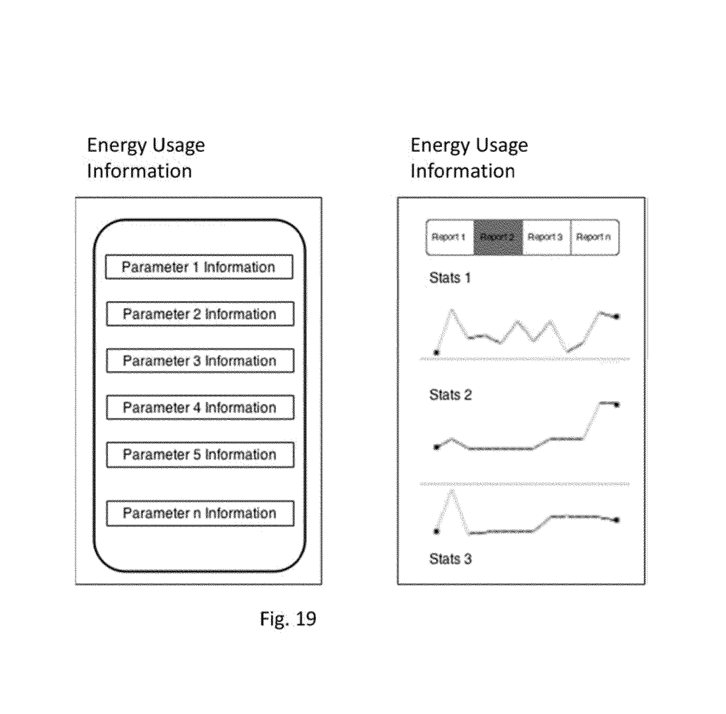

Referring to FIGS. 18 and 19, these show mobile application's screens and functions available for showing energy usage of connected appliances to the user. User can make energy saving decisions from this vital information and contribute to global challenges of saving energy.

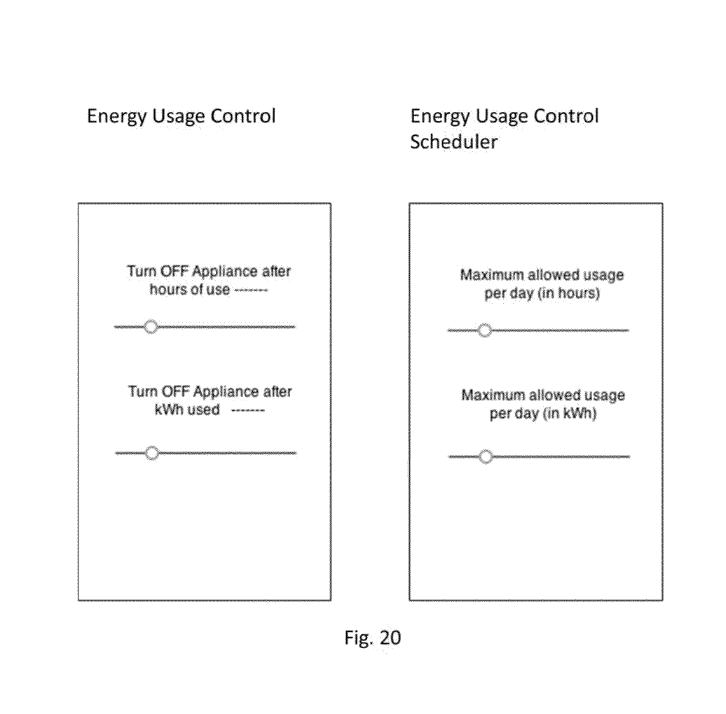

Referring to FIG. 20, it shows mobile application's screens and functions available for energy usage control measures. User can make energy saving decisions and restrict energy usage of various appliances associated to smart electrical switches.

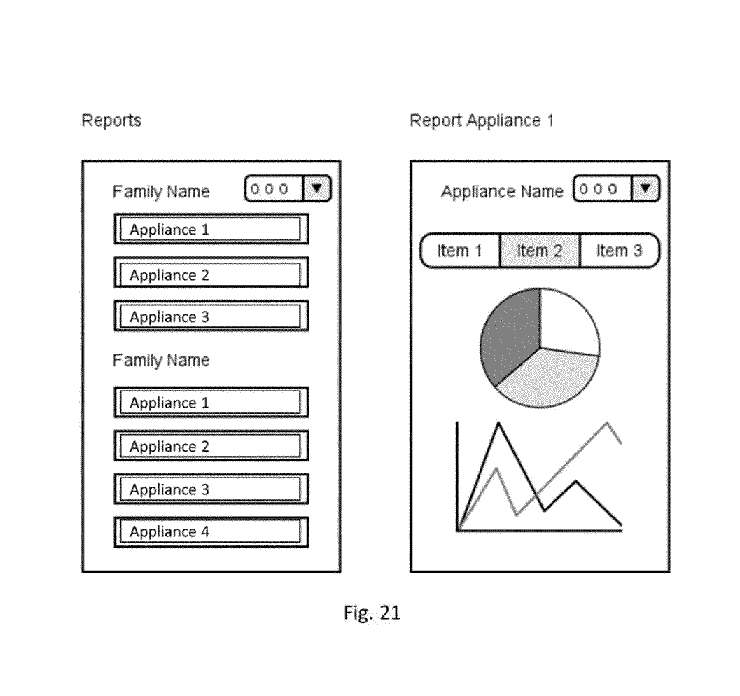

Referring to FIG. 21, it shows mobile application's family associated appliances and graphical reports of specific appliance screens. List of appliances associated with a specific family is shown. There can be more than one families registered and more than one appliances associated with each family.

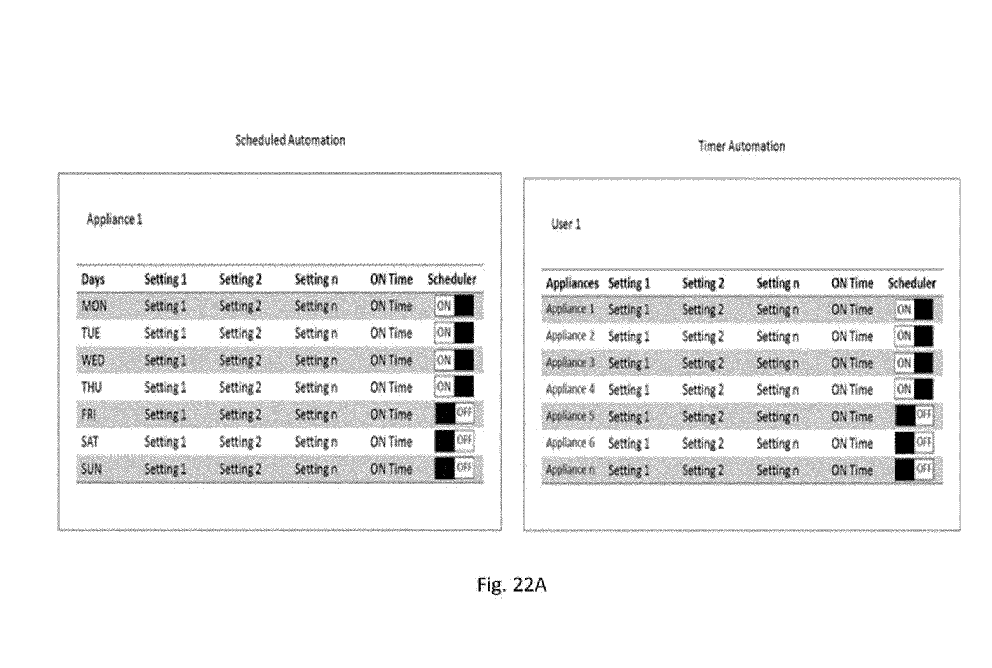

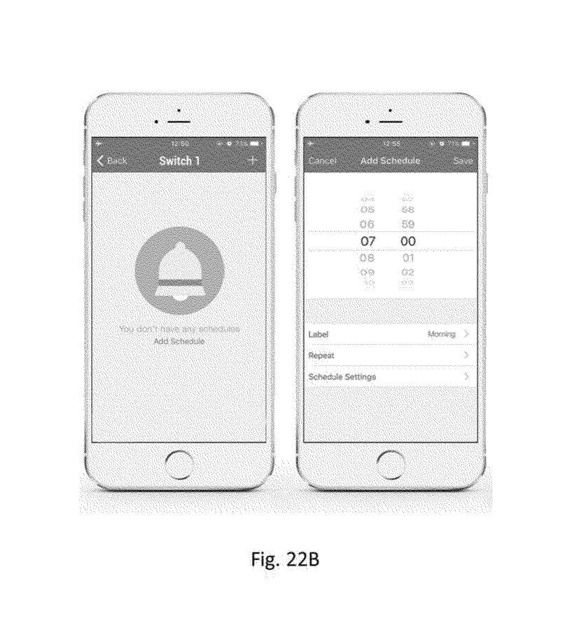

Referring to FIG. 22A-B, it shows mobile application's automatic timed and scheduled operation triggering screens. Scheduled automation shows the options of a particular appliance related to automatic triggering a number of user-specific settings over the days of a week. The scheduler can be turned on or off in variable days of the week. Timer automation shows the options of a particular user related to automatic triggering a number of user-specific appliance settings over all the associated user appliances. The timer can be turned on or off for variable appliances.

There is a multitude of advantages of the presented invention arising from the various features of the smart electrical switch, its methods, sub systems, algorithms and associated applications. It is pertinent to note that alternative embodiments of the present invention may not cover all of the associated features of the invention. People having ordinary skills in the art may benefit and devise their own implementations of the smart electrical switch, utilizing one or more of the features of present invention which fall within the scope of the present invention as defined by the appended claims.

FIGS. 22A-22B are display diagrams illustrating scheduling functionality in accordance with some embodiments of the technology. The technology enables users to set schedules and automated timers for operating an appliance associated with a smart electrical switch, such as turn ON the appliance. FIG. 22A shows a graphical user interface 2210 where a user can select settings to be automatically performed on selected appliances over the days of the week. Timer automation screen 2220 enable a user to automatically trigger a number of user-specific settings over appliances coupled to online smart electrical switches.

FIG. 22B shows a scheduling interface for the smart electrical switch. The scheduling functionality enables a user to schedule functions to be performed over time. Functions may include turning ON/OFF the appliance at specific times, or operating the appliance in a low power mode. The scheduling functionality is handled by a “Schedule Protocol” by which schedules that are added by a user against any smart electrical switch 10 are also sent to the smart electrical switch 10. Schedules can be deleted, enabled, or disabled by the user using the custom software application installed on a user device such as a mobile phone, tablet, smart watch, TV, etc.

In some embodiments, the cloud platform 50 sends a fixed number of schedules or schedule events to smart electrical switch 10 to be executed after processing, along with data string and timestamp, and stores the remaining schedules or schedule events as a queue in its database. Smart electrical switch 10 sends an acknowledgment for each schedule information. When the schedule is executed, device 10 sends a schedule execution acknowledgement to cloud platform 50 along with the timestamp information of that schedule. The cloud platform 50 marks that schedule as completed and then gets pending schedules and sends them to device 10. Normally, schedules to be executed next are stored in the smart electrical switch 10 memory to ensure that schedules work even if internet connection to the cloud platform 50 is not available.

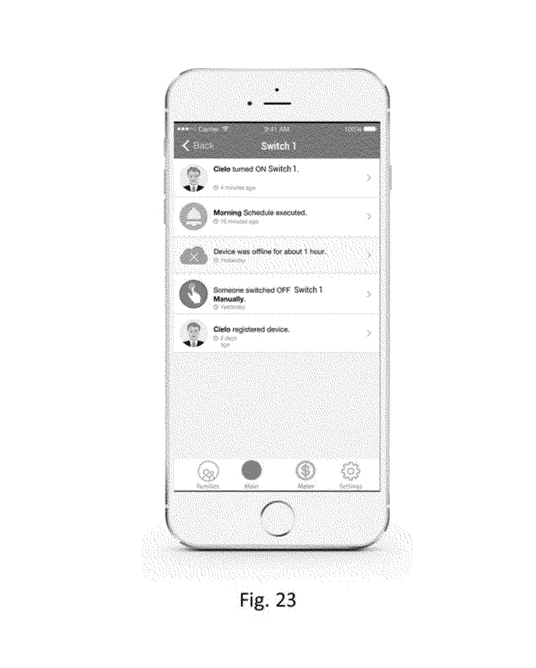

FIG. 23 is a display diagram illustrating a timeline view in accordance with some embodiments of the technology. Timeline view 2300 enables a user to see actions performed on smart electrical switch 10 and observed through smart electrical switch 10 therefore providing a complete audit trail. In the shown timeline view 2300, item 2302 is the oldest item and indicates that Cielo registered device named “Switch 1” two days ago. Item 2304 indicates that “Someone switched OFF Switch 1 MANUALLY”. In some embodiments, smart electrical switch 10 captures and reports status information that are displayed in timeline view 2300. Item 2306 indicates that Switch 1 was offline for an hour. Item 2308 indicates that a schedule labeled “Morning” was executed ten minutes ago. Item 2310 indicates that Cielo turned ON Switch 1 four minutes ago. In some embodiments, the technology provides auditing functions based on observed timeline events, such as an alert that a function was performed outside normal hours.

There is a multitude of advantages of the presented invention arising from the various features of the smart electrical switch, its methods, subsystems, algorithms and associated applications. It is pertinent to note that alternative embodiments of the present invention may not cover all of the associated features of the invention. People having ordinary skills in the art may benefit and devise their own implementations of the smart electrical switch, utilizing one or more of the features of the present invention which fall within the scope of the present invention as defined by the appended claims.

It will be appreciated by those skilled in the art that the above-described technology may be straightforwardly adapted or extended in various ways. For example, the technology may be implemented in devices of various sizes and forms, as standalone devices or integrated or retrofitted into appliances. While the foregoing description makes reference to particular embodiments, the scope of the invention is defined solely by the claims that follow and the elements recited therein.

What is claimed is:

1. A programmable electrical switch comprising:
a control circuit configured to be coupled to an electrical power supply, and to a load device;
the control circuit comprising:
a communication module configured to receive at least one RF packet comprising at least one of a control command and a configuration command;
a processing module for processing the at least one control command and the one configuration command, and generating operational signals;
a control module for receiving the operational signals and executing functions associated with the operational signals;
an energy measurement and reporting module configured for measuring and reporting energy consumption of the load device.

2. The programmable electrical switch of claim 1, wherein the communication module comprises a Wi-Fi communication transceiver.

3. The programmable electrical switch of claim 1, wherein the load device is an consumer appliance.

4. The programmable electrical switch of claim 1, where the load device is a ceiling fan, or a light bulb.

5. The programmable electrical switch of claim 1, wherein the communication module is operative to form a network with at least one other transceiver.

6. The programmable electrical switch of claim 1, wherein the control circuit is configured to receive a state change command from a user over a network.

7. The programmable electrical switch of claim 6, wherein the network is at least one of a wireless local area network, and an ad-hoc network.

8. The programmable electrical switch of claim 1, wherein the programmable electrical switch operates in a smart control mode based on usage behavior data collected over time.

9. The programmable electrical switch of claim 8, wherein the smart control mode can be enabled or disabled by the user.

10. A method in a networked control system for remotely activating and deactivating at least one appliance associated with a programmable electrical switch, the method comprising:
determining a list of online electrical switches associated with a user profile,
displaying the list of the online electrical switches on a user communication device,
receiving, over a communication network, a command from the user communication device to control the operating state of the at least one appliance,
controlling the operating state responsive to the command.

11. The method of claim 10, wherein displaying the list of the online electrical switches includes grouping the electrical switches according to a user predefined selection.

12. The method of claim 10, wherein the communication network is at least one of a wireless LAN network, and an ad-hoc network.

13. The method of claim 10, further comprising:
monitoring an energy consumption of the appliance; and
altering the operation of the appliance responsive to the energy consumption exceeding an energy consumption threshold.

14. The method of claim 10, further comprising:
periodically sending at least one of a report of energy consumption of an appliance associated with the programmable electrical switch, and actions performed on the appliance, to a remote server.

15. The method of claim 13, wherein the energy consumption threshold relates to a time period in which the light producing device has been producing light.

16. A remote control system for changing the operating state of an appliance over a communication network, the system comprising:
a managed cloud computing platform, comprising at least one processor and memory,
a user interface component displayed on a user computing device operably connected with the cloud computing platform; and
a programmable electrical switch having a communication module, the electrical switch operably connected to the managed cloud platform via the communication module and configured to be associated with an appliance, and configured to receive a command from a user over the communication network to control the operating state of the appliance.

17. The remote control system of claim 16 wherein the user interface component is configured to display a list of electrical switches that are capable of receiving a control command.

18. The remote control system of claim 16 wherein programmable electrical switch is operative to form a network with at least one other transceiver via said communication module.

19. The remote control system of claim 16 further comprising an energy consumption monitoring and reporting module configured to periodically report energy consumption to a remote server.

20. The remote control system of claim 19, wherein the energy consumption relates to a time period in which an appliance has been operating.
